(19) United States
(12) Patent Application Publication
(10) Pub. No.: US 2026/0094058 A1
(43) Pub. Date: Apr. 2, 2026

(54) ASYNCHRONOUS MICROSERVICE-BASED SUPERVISED LEARNING FOR ADAPTIVE MESSAGE QUEUE PRIORITIZATION IN DATA PROTECTION OPERATIONS

(71) Applicant: Dell Products L.P., Round Rock, TX (US)

(72) Inventors: Avinash Kumar, Patna (IN); Nitesh Kumar Pandey, Bangalore (IN); Shelesh Chopra, Bangalore (IN); Gururaj Kulkarni, Bangalore (IN); Mahantesh M. Ambaljeri, Bangalore (IN)

(21) Appl. No.: 18/903,744

(22) Filed: Oct. 1, 2024

(51) Int. Cl. G06N 20/00

(52) U.S. Cl. CPC G06N 20/00

(57) ABSTRACT

A method for message prioritization includes obtaining, by a message prioritization service, data comprising a first set of messages, each message in the data being associated with communication between a production environment and a data protection system. In response to obtaining the data, the method further includes: performing a data pre-processing on the data to obtain processed data and to identify features, performing a data partitioning of the processed data to obtain a training set and a testing set, performing a model training on the training set using the features by applying a k-nearest neighbors (KNN) algorithm on the training set to obtain a trained model, and deploying the trained model in a data protection system to perform message prioritization of messages.

### BACKGROUND

In a large-scale data environment, thousands of payloads may be created and destroyed on a daily basis, high volumes of asynchronous message transfers may be performed. The possibility exists for scenarios in which computing devices in the data environment must undergo disaster failover or otherwise become unavailable during the asynchronous message transfers.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2 shows a flowchart of a method for managing message prioritization in accordance with one or more embodiments of the invention.

FIG. 3 shows an example in accordance with one or more embodiments of the invention.

FIG. 4 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details, and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this disclosure, elements of figures may be labeled as A to N, A to P, A to M, or A to L. As used herein, the aforementioned labeling means that the element may include any number of items, and does not require that the element include the same number of elements as any other item labeled as A to N, A to P, A to M, or A to L. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, operably connected, or operative connection, means that there exists between elements, components, and/or devices a direct or indirect connection that allows the elements to interact with one another in some way. For example, the phrase ‘operably connected’ may refer to any direct (e.g., wired directly between two devices or components) or indirect (e.g., wired and/or wireless connections between any number of devices or components connecting the operably connected devices) connection. Thus, any path through which information may travel may be considered an operable connection.

Embodiments disclosed herein include supervised learning-based systems and methods for determining the criticality score of data protection tasks and messages associated with such tasks based on both content and context. Embodiments of the invention include generating a prioritized list of message requests during the asynchronous message transfer between the microservices, of a data protection system, leveraging the message broker for consumption by consumers. A trained dataset includes multiple labeled parameters, reflecting the importance of both the content and context of task messages. Embodiments of the invention include leveraging a K-Nearest Neighbors (KNN) algorithm. The KNN algorithm may include classifying a data point (e.g., a message) based on the majority class of its k nearest neighbors in a feature space. In one or more embodiments, the labeled parameters extracted from the content and context of task request messages serve as features in the feature space of the KNN algorithm.

In one or more embodiments, each microservice involved in asynchronous communication for specific workflows (such as server disaster recovery, backup, restore, indexing, etc.) would use a routing slip pattern with priority assigned to each message by a machine learning-driven algorithm (such as KNN). A message prioritization service may periodically probe the communication between a production environment and a data protection system via a message bus and prioritize high-priority messages tagged for the given workflow. The routing slip pattern may then be used to determine the overriding or throttling for other workflows being executed by data movers based on priority characteristics.

Various embodiments of the invention are described below.

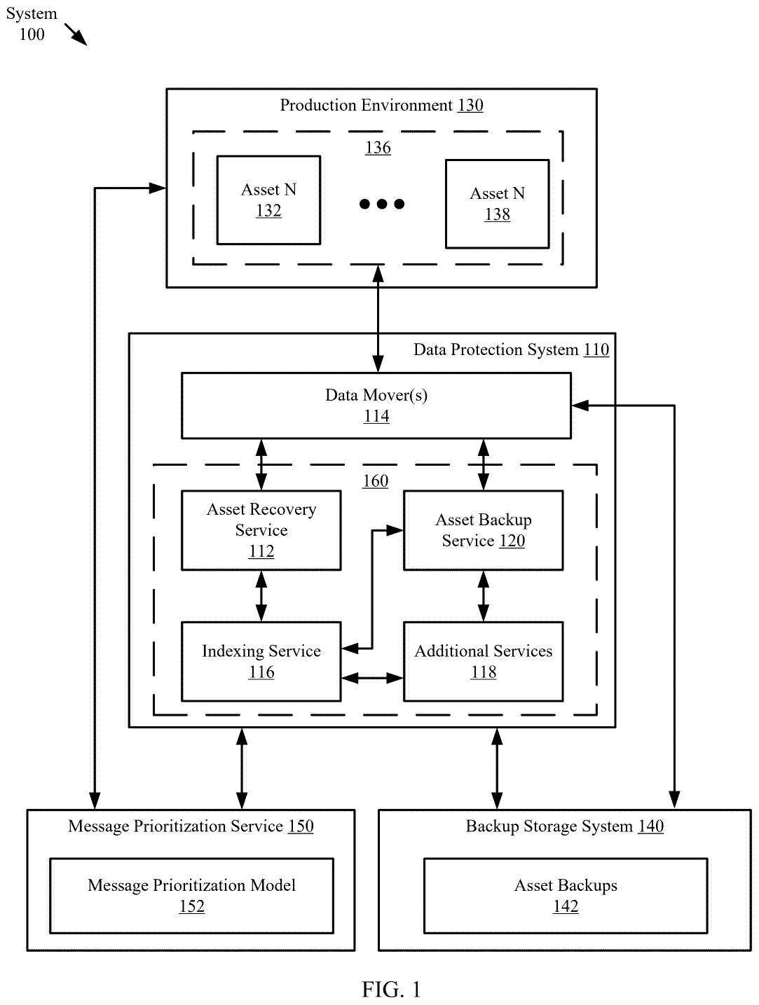

FIG. 1 shows an example system in accordance with one or more embodiments of the invention. The system includes a production environment (130), a data protection system (110), a backup storage system (140), and a message prioritization service (150). The components in the system may be operably connected via any combination of wired and/or wireless connections. The system may include additional, fewer, and/or different components without departing from the invention. Each component in the system is operably connected via any combination of wired and/or wireless connections.

In one or more embodiments disclosed herein, the production environment (130) provides services to users operating the production environment (130). The services may be provided using applications (not shown) executing on the production environment (130). The applications may be logical entities executed using computing resources of the production environment (130). For example, the applications may host components. The components may be, for example, instances of databases, email servers, operating systems, virtual machines, and/or other components. The applications may host other types of components without departing from the invention.

The applications may generate, use, or otherwise access any number of assets (136) stored in the production environment. The assets (136) may each be data structures that, when utilized by the production environment (130), provide the services to the users. Examples of assets (132, 138) include, but are not limited to, databases, virtual machine disks, virtual disks, file systems, application data, and streaming data.

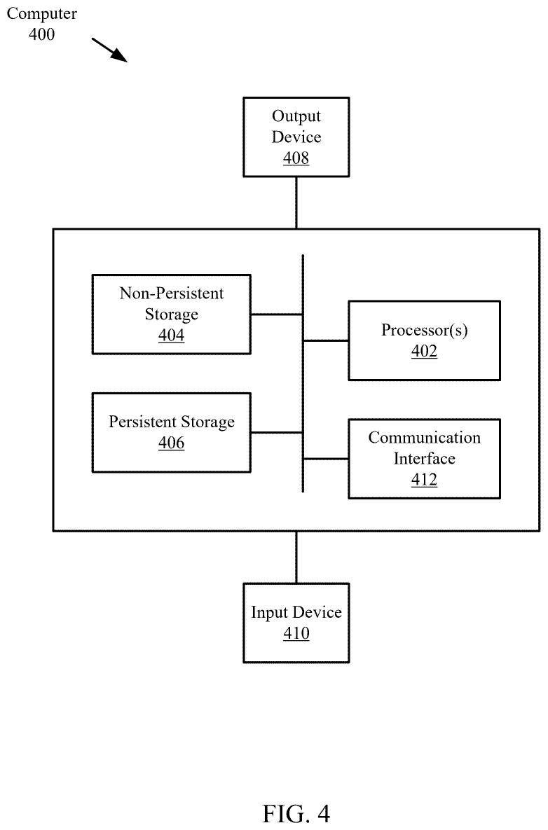

In one or more embodiments, the production environment (130) is implemented as a computing device (see e.g., FIG. 4). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the production environment (130) described throughout this application.

In one or more embodiments disclosed herein, the production environment (130) is implemented as a logical device. The logical device may utilize the computing resources of any number of computing devices and thereby provide the functionality of the production environment (130) described throughout this application.

In one or more embodiments, the assets (136) are protected using a data protection system (110). The data protection system (110) includes functionality for servicing data protection tasks such as backing up, restoring, and indexing the assets (136). The assets may be backed up in a backup storage system (140) that stores the asset backups (142). To provide the data protection tasks, the data protection system (110) includes one or more data movers (114), and microservices (160) such as an asset recovery service (112), an asset backup service (120), an indexing service (116), and any other additional services (118). The data protection system (110) may include additional, different, and/or different components without departing from the invention.

In one or more embodiments, the data movers (114) include functionality for performing data transfer of asset data to and/or from the production environment (130). The data movers (114) may store asset backups (142) in the backup storage system and recover the asset backups (142) to the production environment (130) in accordance with tasks initiated by the microservices (160).

In one or more embodiments, the asset recovery service (112) is implemented as a microservice that obtains and services requests for restoring assets from the backup storage system (140) to the production environment (130). The asset backup service (120) may be implemented as a microservice that obtains and services requests for backing up assets (136) to the backup storage system (140). The indexing service (116) may be implemented as a microservice that indexes stored assets, stored asset backups (142), and/or other entities for reference by the production environment (130). Additional services (118) may each be implemented as microservices.

In one or more embodiments, each of the aforementioned microservices (160) is involved in asynchronous communication with the production environment (130). In one or more embodiments, asynchronous communication refers to the use of one or more queues (not shown) to organize the incoming requests for tasks serviced by the microservices (160). The queues may specify (e.g., in memory or persistent storage) the data protection tasks yet to be completed or started. The tasks may be ordered based on policies implemented by the data protection system. In a data protection system (110) in accordance with one or more embodiments of the invention, a high number of tasks may be serviced in a given day. For example, thousands of data protection tasks may be requested by the production environment (130). As the data protection tasks are initiated, they may be stored in the queues.

In one or more embodiments, due to the asynchronous nature of communication between the production environment (130) and the data protection system (110), the data protection system (110) is at risk of receiving a request for a data protection task and undergoing a failover or otherwise becoming unavailable before sending a response to the request.

In one or more embodiments disclosed herein, the data protection system (110) is implemented as a computing device (see e.g., FIG. 4). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the data protection system (110) described throughout this application.

In one or more embodiments disclosed herein, the data protection system (110) is implemented as a logical device. The logical device may utilize the computing resources of any number of computing devices and thereby provide the functionality of the data protection system (110) described throughout this application.

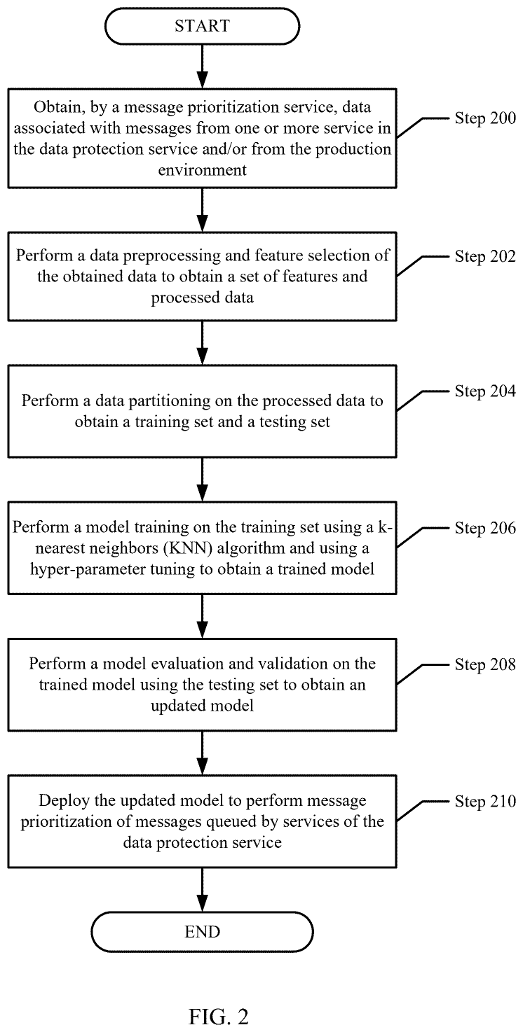

To manage possibilities of a failover, and to manage prioritization of data protection tasks, a message prioritization service (152) includes functionality for managing the prioritization of messages associated with the data protection tasks. The prioritization may be managed by generating and fine-tuning a message prioritization model (152) using data obtained from previous communication. The message prioritization model (152) may be deployed in the data protection system (110) to prioritize queued messages based on both content and context of the tasks. The prioritization of messages, generation of the message prioritization model (152), and subsequent deployment of the generated message prioritization model (152) may be performed by the message prioritization service (150) in accordance with the method of FIG. 2. Other methods or processes may be performed without departing from the invention.

In one or more embodiments disclosed herein, the message prioritization service (150) is implemented as a computing device (see e.g., FIG. 4). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the message prioritization service (150) described throughout this application.

In one or more embodiments disclosed herein, the message prioritization service (150) is implemented as a logical device. The logical device may utilize the computing resources of any number of computing devices and thereby provide the functionality of the message prioritization service (150) described throughout this application.

While the system of FIG. 1 has been illustrated and described as including a limited number of specific components, a system in accordance with embodiments of the invention may include additional, fewer, and/or different components without departing from the invention.

FIG. 2 shows a flowchart for managing message prioritization in accordance with one or more embodiments of the invention. The method shown in FIG. 2 may be performed by, for example, a message prioritization service (130, FIG. 1). Other components of the system illustrated in FIG. 1 may perform the method of FIG. 2 without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

Turning to the method, in step 200, data associated with messages are obtained from one or more services in the data protection system and/or from the production environment. The data may include messages associated with the communication between the production environment and the data protection system for data protection tasks.

In step 202, a data pre-processing and a feature selection of the obtained data are performed to obtain processed data and a set of features. The data pre-processing may include data cleaning to remove any irrelevant information such as stop words, punctuation, and special characters. The data pre-processing may further include stemming and lemmatization of the data. Further, the feature selection includes identifying relevant features of the data such as, for example, a payload type of each message, a criticality of data in each message, a size of data in each message, a dependency of a process in the message to another process, a recovery point objective (RPO) of the payload type of the message, a task type priority of the message, and a priority listing for data protection tasks. The payload type may reference a type of asset specified in the message (e.g., a virtual machine, a database, a network attached storage (NAS) filer, a virtual disk, etc.). The priority listing may indicate pre-defined policies for prioritizing messages. A priority listing may specify, for example, that a restoration of one payload type is prioritized over a backup of the payload type, a full backup is prioritized over indexing tasks, and prioritizing monitoring tasks over full backups. Additional features associated with the data may include service level agreement (SLA) requirements associated with a data protection task of a message, recovery point objectives (RPOs) for each payload type, and recovery time objectives (RTOs) of the payload type.

In one or more embodiments, each feature may be associated with either the content or context of the data protection tasks. The context may refer to the nature of the data protection system and the priorities of the tasks. For example, the priority listings may be associated with the context. In contrast, the content may refer to the information included in the message, such as the data size and a payload type of the message.

In one or more embodiments, the feature selection includes performing feature engineering on the identified features. The feature engineering may include generating new features based on the identified ones discussed above. For example, a composite feature may be calculated representing an overall urgency of a message based on the criticality of the data and the SLA requirements. In another example, a feature that indicates a level of interdependencies between tasks may be generated by analyzing the relationships between payload types and specified tasks. Other features may be generated based on, for example, a frequency of requests to access given NAS assets over time or trends in historical performance metrics of serviced messages.

In step 204, a data partitioning is performed on the processed data to obtain a training set and a testing set. In one or more embodiments, the data partitioning includes assigning each message in the processed data to either a testing set or a training set. The training set may be used for the model training of step 206; the testing set may be used for model evaluation and validation of step 208. The data partitioning may be performed via any mechanism without departing from the invention.

In step 206, a model training is performed on the training set using a supervised machine learning model to obtain a trained model. In one or more embodiments, the supervised machine learning model is a k-nearest neighbor (KNN) model. The training includes identifying optimal parameters for effective prioritization of data protection tasks. Each message in the training set is represented as a data point with multi-dimensional feature space. The model training includes computing distances between data points in relation to the multi-dimensional feature space using a Eucliedian distance metric to determine similarities between data points. A parameter value of k is determined for the model training and used to represent a number of nearest neighbors considered in a classification. The selection of a k value may be based on techniques such as cross-validation, and used to balance the model's bias-variance tradeoff to ensure optimal performance on unseen data (e.g., future messages). The model training further includes iteratively classifying messages based on a majority class among the k nearest neighbors by computing the distances between each data point in the training set and its k nearest neighbors, assigning a weight to each neighbor based on its distance to a given data point, and determining a class label of the data point based on the weighted votes of its neighbors. Each data point in a classification may be assigned an identical prioritization. For example, a first category may include a critical container group, and a second category may include a non-critical container group.

In step 208, a model evaluation and validation is performed on the trained model using the testing set to obtain an updated model. In one or more embodiments, the model evaluation is performed to find the efficacy in prioritizing data protection tasks accurately. The model evaluation may include utilizing the testing set, including unseen data, to assess the model's predictive capabilities. For each task request message in the testing set, the trained model predicts its criticality score. Evaluation metrics like accuracy, precision, recall, F1-score, and area under the receiver operating characteristic curve (AUC-ROC), are computed to increase the model's performance. By comparing these metrics against predefined thresholds or benchmarks, the model's classification of messages to prioritize tasks based on content and context attributes are analyzed. A hyper-tuning of parameters of the trained model is performed to perform the validation and updating the trained model.

In step 210, the updated model is deployed to perform message prioritization of messages queued by services of the data protection system. In one or more embodiments, the updated message prioritization model is deployed in the data protection system by inputting a received message to the message prioritization model (e.g., 152, FIG. 1) and outputting a prioritization such as a criticality score, and including the output into the message for services to use when processing.

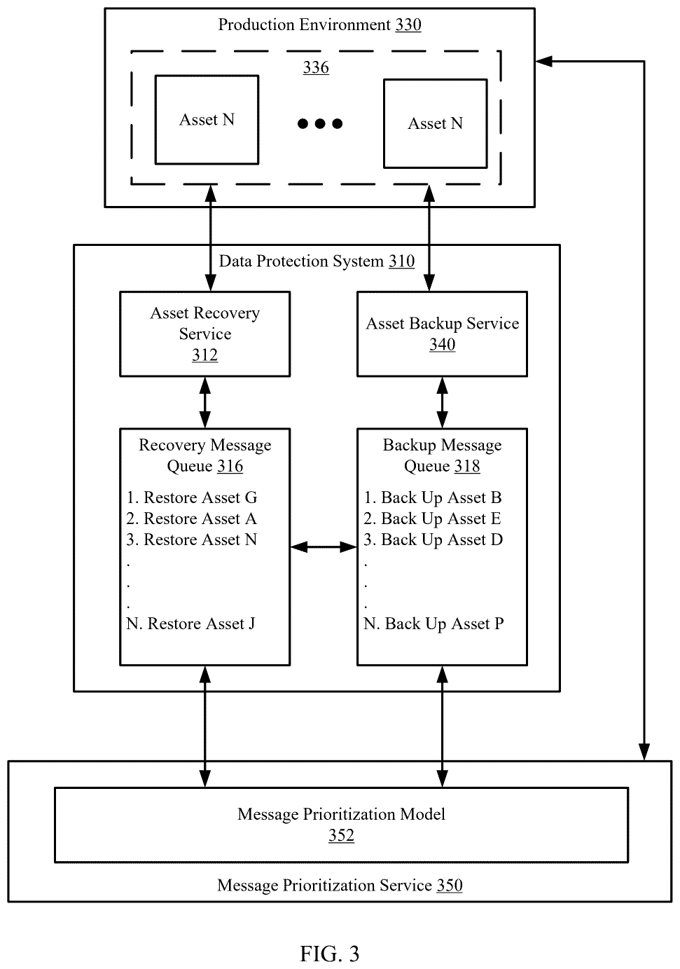

In one or more embodiments, the services (e.g., 160, FIG. 1) implement a routing slip pattern to service the messages for processing in the queues. The routing slip pattern refers to the use of a configuration specified in the message for an order of performing the services in the data protection system. In this manner, the queues are modified to prioritize the more critical messages (such as requests for backups, restoration of assets, etc.) Example To clarify aspects of the invention, the following describes an example in accordance with one or more embodiments of the invention. The example, described using FIG. 3, is not intended to limit aspects of the invention. In the example, consider a scenario in which a data protection system provides systems and methods for data protection tasks such as backing up assets, restoring the assets, or indexing services of the backed up assets.

Turning to the example, FIG. 3 shows a diagram of an example system in accordance with one or more embodiments of the invention. The example system includes a production environment (330) that issues requests for data protection tasks to a data protection system (310). The data protection system (310) may include an asset recovery service (312) and an asset backup service (340). A message prioritization service (350) performs the method of FIG. 2 to generate and deploy a message prioritization model (352) for prioritizing messages.

The data protection system (310) performs asynchronous communication by using queues (316, 318) for storing unserviced requests for backups and restorations of assets. The message prioritization service (350), by implementing a trained model (352) in the data protection system (310), organizes the queues (316, 318) based on criticality scores determined for each data protection task. For example, asset G may be deemed a more critical asset than asset A and asset N. As such, the restoration of asset G may be prioritized by the data protection system (310) over the backups of assets B and E. The recovery message queue (316) and the backup message queue (318) may be ordered based on a determined prioritization of the message prioritization model (352). The services (312, 340) may perform their respective data protection tasks in accordance with the generated order in the corresponding message queues (316, 318).

### End of Example

As discussed above, embodiments of the invention may be implemented using computing devices. FIG. 4 shows a diagram of a computing device in accordance with one or more embodiments of the invention. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment of the invention, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

One or more embodiments of the invention may improve the operation of one or more computing devices. More specifically, embodiments of the invention provide dynamic priority assignment of messages based on real-time analysis of message content and context using a supervised machine learning algorithm such as KNN.

Further, current implementations of message prioritization lack adaptability to changing circumstances. As such, embodiments of the invention provide adaptability to the message prioritization by considering the dynamic nature (e.g., context) of data protection tasks. Considering features of the context and features associated with content of the messages, embodiments of the invention provide efficient and real-time message re-prioritization.

Embodiments of the invention may scale efficiently with complex and large-scale environments, adapting to the dynamic flow of message requests without predefined constraints.

Thus, embodiments of the invention may address the problem of inefficient use of computing resources. This problem arises due to the technological nature of the environment in which file systems are utilized.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A method for managing asynchronous message transfer, the method comprising:
obtaining, by a message prioritization service, data comprising a first set of messages, wherein each of the first set of messages is associated with communication between a production environment and a data protection system; and
in response to obtaining the data:
performing a data pre-processing on the data to obtain processed data, wherein the data pre-processing comprises identifying features of the data associated with the communication;
performing a data partitioning of the processed data to obtain a training set and a testing set;
performing a model training on the training set using the features by applying a k-nearest neighbors (KNN) algorithm on the training set to obtain a trained model; and
deploying the trained model in the data protection system to perform message prioritization of messages.

2. The method of claim 1, wherein the first set of messages comprise at least one of each of a list consisting of: a request to back up an asset of the production environment, a response to the request to back up, a request to recover the asset, a response to the request to recover, and a request to index a set of assets.

3. The method of claim 2, wherein the request to back up and the response to the request to backup are sent asynchronously.

4. The method of claim 1, wherein the features are each associated with either a content or a context of the first set of messages.

5. The method of claim 4, wherein the features each comprise one of a list consisting of: a payload type of a message, a criticality of data in the message, a size of data in the message, a dependency of a process in the message to another process, a recovery point objective (RPO) of the payload type of the message, a task type priority of the message, and a priority listing for data protection tasks.

6. The method of claim 1, further comprising:
after the deploying, receiving a new message associated with the communication between the production environment and the data protection system;
performing a feature selection to identify a subset of the features for the new message;
applying the subset of the features to the trained model to obtain a priority assignment of the new message; and
storing the new message in a queue of the data protection system based on the priority assignment.

7. The method of claim 6, further comprising: updating the trained model based on the priority assignment and based on the storing.

8. A non-transitory computer readable medium comprising computer readable program code, which when executed by a computer processor enables the computer processor to perform a method for managing data access, the method comprising:
obtaining, by a message prioritization service, data comprising a first set of messages, wherein the first set of messages are associated with communication between a production environment and a data protection system; and
in response to obtaining the data:
performing a data pre-processing on the data to obtain processed data, wherein the data pre-processing comprises identifying features of the data associated with the communication;
performing a data partitioning of the processed data to obtain a training set and a testing set;
performing a model training on the training set using the features by applying a k-nearest neighbors (KNN) algorithm on the training set to obtain a trained model; and
deploying the trained model in a to perform message prioritization of messages.

9. The non-transitory computer readable medium of claim 8, wherein the first set of messages comprise at least one of each of a list consisting of: a request to back up an asset of the production environment, a response to the request to back up, a request to recover the asset, a response to the request to recover, and a request to index a set of assets.

10. The non-transitory computer readable medium of claim 9, wherein the request to back up and the response to the request to backup are sent asynchronously.

11. The non-transitory computer readable medium of claim 8, wherein the features are each associated with either a content or a context of the first set of messages.

12. The non-transitory computer readable medium of claim 11, wherein the features each comprise one of a list consisting of: a payload type of a message, a criticality of data in the message, a size of data in the message, a dependency of a process in the message to another process, a recovery point objective (RPO) of the payload type of the message, a task type priority of the message, and a priority listing for data protection tasks.

13. The non-transitory computer readable medium of claim 8, further comprising:
after the deploying, receiving a new message associated with the communication between the production environment and the data protection system;
performing a feature selection to identify a subset of the features for the new message;
applying the subset of the features to the trained model to obtain a priority assignment of the new message; and
storing the new message in a queue of the data protection system based on the priority assignment.

14. The non-transitory computer readable medium of claim 13, further comprising: updating the trained model based on the priority assignment and based on the storing.

15. A system, comprising:
a processor, and
memory comprising instructions, which when executed by the processor, cause the processor to perform a method, the method comprising:
obtaining, by a message prioritization service, data comprising a first set of messages, wherein the first set of messages are associated with communication between a production environment and a data protection system; and
in response to obtaining the data:
performing a data pre-processing on the data to obtain processed data, wherein the data pre-processing comprises identifying features of the data associated with the communication;
performing a data partitioning of the processed data to obtain a training set and a testing set;
performing a model training on the training set using the features by applying a k-nearest neighbors (KNN) algorithm on the training set to obtain a trained model; and
deploying the trained model in a to perform message prioritization of messages.

16. The system of claim 15, wherein the first set of messages comprise at least one of each of a list consisting of: a request to back up an asset of the production environment, a response to the request to back up, a request to recover the asset, a response to the request to recover, and a request to index a set of assets.

17. The system of claim 16, wherein the request to back up and the response to the request to backup are sent asynchronously.

18. The system of claim 15, wherein the features are each associated with either a content or a context of the first set of messages.

19. The system of claim 18, wherein the features each comprise one of a list consisting of: a payload type of a message, a criticality of data in the message, a size of data in the message, a dependency of a process in the message to another process, a recovery point objective (RPO) of the payload type of the message, a task type priority of the message, and a priority listing for data protection tasks.

20. The system of claim 15, further comprising:
after the deploying, receiving a new message associated with the communication between the production environment and the data protection system;
performing a feature selection to identify a subset of the features for the new message;
applying the subset of the features to the trained model to obtain a priority assignment of the new message;
storing the new message in a queue of the data protection system based on the priority assignment; and
updating the trained model based on the priority assignment and based on the storing.
